(19) United States
(12) Patent Application Publication
(10) Pub. No.: US 2012/0200240 A1
(43) Pub. Date: Aug. 9, 2012

(54) VIBRATION-TYPE DRIVE APPARATUS, AND CONTROL METHOD FOR VIBRATION-TYPE DRIVE APPARATUS

(75) Inventors: Ryuichi Yoshida, Sakai-shi (JP); Satoshi Shinke, Kokubunji-shi (JP)

(73) Assignee: KONICA MINOLTA ADVANCED LAYERS, INC., Tokyo (JP)

(21) Appl. No.: 13/502,192

(22) PCT Filed: Oct. 6, 2010
(86) PCT No.: PCT/JP2010/067534

§ 371 Date: Apr. 16, 2012

Related U.S. Application Data
(66) Substitute for application No. PCT/JP2010/067534, filed on Oct. 6, 2010.

(30) Foreign Application Priority Data
Oct. 19, 2009 (JP) 2009-240309

(51) Int. Cl. H02N 2/06

(52) U.S. Cl. 318/116

(57) ABSTRACT

A drive apparatus includes: an electromechanical transducer element wherein mechanical displacement will occur when a voltage is applied thereto, a drive member that is moved by the electromechanical transducer element, a moving member that engages with the drive member so as to be able to make a slipping displacement relative to the same, regulating members for limiting the movement of the moving member by coming into contact with the moving member, a drive circuit for applying a cyclical drive voltage to the electromechanical transducer element, a detecting circuit for detecting the impedance of the electromechanical transducer element, and an evaluating means for determining that the moving member is in contact with one of the regulating members when the value detected by the detecting circuit is not less than a prescribed value.

### TECHNICAL FIELD

The present invention relates to vibration-type drive apparatuses and control methods of the vibration-type drive apparatuses.

### BACKGROUND ART

A vibration-type drive apparatus is well known in which a moving member, which is frictionally engaged to a drive member, is slidingly displaced in an axial direction with respect to the drive member by asymmetrically vibrating the drive member in a sawtooth manner in the axis direction by an electromechanical transducer element for converting voltage into mechanical displacement. A displacement distance of the moving member of the vibration-type drive apparatus for one cycle of a drive voltage applied to the electromechanical transducer element is not strictly the same; thus an actual position of the moving member may be in some cases deviated from a position expected by the drive voltage. To deal with this issue, in the positioning by a conventional vibration-type drive apparatus, a sensor must be provided to detect the position of the moving member as described in Patent Document 1.

Alternatively, as a simple configuration, there has been proposed another apparatus in which a member for defining a movable range of a moving member by contacting the moving member is provided, and a positioning error of the moving member is corrected such that after the moving member is once moved to one end of the movable range by applying a drive voltage enough for moving the moving member by a sufficiently long distance over the movable range, the moving member is supplied with a drive voltage just for moving the moving member to a desired position with respect to this end of the movable range as a reference point.

However, in this configuration the drive voltage needs to be supplied for a certain period after the moving member has reached the end of the movable range, whereby it takes a long time to drive, which is troublesome. For example, in the case of scanning and moving the moving member in the X-Y direction by two vibration-type drive apparatuses, the moving member needs to be moved to the end of the movable range every one scan, whereby these excessive pieces of time are accumulated to be a great time loss.

In addition, a conventional vibration-type drive apparatus employs slide displacement, and the moving member keeps sliding on the drive member and the electromechanical transducer element keeps vibrating after the moving member has reached the end of the movable range. Thus, there is a problem that an uneven wear tends to be created in the drive member and the like at the vicinity of the end of the movable range. Such uneven wear may cause an unusual friction, thereby making the moving member is temporarily stuck to the drive member at the end of the movable range; thus when the drive voltage is supplied to move the moving member from the end of the movable range, there is a moment before the moving member starts moving, whereby the moving member sometimes cannot be positioned at a desired position.

There may be an idea that a sensor is provided to detect when the moving member reaches the end of the movable range to eliminate excessive drive at the end of the movable range; however the cost must be increased since an expensive sensor must be used since the detection accuracy of the sensor is directly related to the accuracy of positioning.

### RELATED ART DOCUMENT

### Patent Document

Patent Document 1: Japanese Laid-Open Patent Application Publication No. 2000-78861

### SUMMARY OF THE INVENTION

### Problems to be Solved by the Invention

In view of the above problems, an object of the present invention is to provide an vibration-type drive apparatus which is low in cost and is capable of detecting when the moving member reaches the end of the movable range, and to provide a method for controlling a vibration-type drive apparatus in which excessive drive voltage is not supplied to position the moving member.

### Means for Solving the Object

In order to solve the above problems, a vibration-type drive apparatus of the present invention comprises:

an electromechanical transducer element configured to generate a mechanical displacement in response to a voltage applied thereto;
a drive member configured to be moved by the electromechanical transducer element;
a moving member engaged to the drive member to be able to be slidingly displaced;
a stopper member configured to limit movement of the moving member by contacting the moving member;
a drive circuit configured to apply a cyclically changing drive voltage to the electromechanical transducer element;
a detection circuit configured to detect an impedance of the electromechanical transducer element; and
a determination section configured to determine that the moving member is in contact with the stopper member when a value detected by the detection circuit is equal to or greater than a predetermined value.

According to this configuration, when the moving member contacts the stopper member, the moving member is prevented from moving further to the stopper member side together with the drive member being moved by the displacement of the electromechanical transducer element; thus a force is acted on the electromechanical transducer element so as to limit its displacement, whereby the impedance of the electromechanical transducer element increases. Thus, when the detection value of the impedance is equal to or greater than a certain value, it is determined that the moving member is located at the end of the movable range where the moving member is in contact with the stopper member. With this arrangement, there is no need for a wasteful control in which the drive voltage is supplied to move the moving member further to the stopper member side after moving member has contacted the stopper member, whereby the moving member can be quickly positioned, and the uneven wear of the drive member at the end of the movable range can be prevented.

In addition, in the vibration-type drive apparatus of the present invention, the detection circuit may have a known configuration in which a current value generated by the applied drive voltage is detected by using a sensing resistor.

Further, in the vibration-type drive apparatus of the present invention, the electromechanical transducer element may generate a sawtooth shaped mechanical displacement by application of a voltage.

In addition, according to the present invention, a first aspect is a control method for a vibration-type drive apparatus which includes: an electromechanical transducer element configured to generate a mechanical displacement in response to a voltage applied thereto; a drive member configured to be moved by the electromechanical transducer element; a moving member engaged to the drive member to be able to be slidingly displaced; a stopper member configured to limit movement of the moving member by contacting the moving member, wherein in order to bring the moving member in contact with the stopper member, the control method:

detecting an impedance of the electromechanical transducer element while applying a cyclically changing drive voltage to the electromechanical transducer element; and

stopping the application of the drive voltage when a detection value of the impedance becomes equal to or greater than a predetermined value.

In addition, a second aspect, according to the present invention, of a control method for a vibration-type drive apparatus is a method to stop the moving member at a position a predetermined distance apart from the stopper member, wherein the method:

detecting an impedance of the electromechanical transducer element;

applying a cyclically changing drive voltage to the electromechanical transducer element while a detection value of the impedance is equal to or greater than a predetermined value; and

stopping the application of the drive voltage after a predetermined period of time has elapsed since the detection value of the impedance became less than the predetermined value.

According to these methods, immediately after the moving member contacts the stopper member, the supply of the drive voltage is interrupted; thus, the driving time is short, and the uneven wear of the drive member at the end of the movable range can be thus prevented.

In addition, a third aspect, according to the present invention, of a control method for a vibration-type drive apparatus is a method, wherein the method:

detecting an impedance of the electromechanical transducer element;

applying a cyclically changing drive voltage to the electromechanical transducer element while a detection value of the impedance is equal to or greater than a predetermined value; and

calculating a traveling speed of the moving member by measuring a time from when the detection value of the impedance becomes less than the predetermined value to when the detection value of the impedance becomes again equal to of greater than the predetermined value.

Further, in the first through third aspect, according to the present invention, of a method for a vibration-type drive apparatus, the electromechanical transducer element can generate a sawtooth shaped mechanical displacement in response to application of a voltage.

### Advantage of the Invention

According to the present invention, it is detected based on the impedance of the electromechanical transducer element that the moving member reaches the end of the movable range. Thus, the vibration-type drive apparatus of the present invention does not need to apply an excessive drive voltage, whereby the moving member can be quickly positioned. In addition, the vibration-type drive apparatus of the present invention does not perform excessive drive, and thus an uneven wear of the drive member and the like can be prevented, whereby the accuracy of positioning is not easily deteriorated, frequent calibration is not needed, and the service life is long.

### BRIEF DESCRIPTION OF THE DRAWINGS

FIG. 1 is a circuit diagram of a vibration-type drive apparatus of a first embodiment of the present invention;

FIG. 2 is a diagram showing a waveform of a drive current of the vibration-type drive apparatus of FIG. 1;

FIG. 3 is a flowchart of a control for returning a moving member of the vibration-type drive apparatus of FIG. 1 to the origin;

FIG. 4 is a flowchart of a control for calculating a traveling speed of the moving member of the vibration-type drive apparatus of FIG. 1;

FIG. 5 is a circuit diagram of the vibration-type drive apparatus of a second embodiment of the present invention;

FIG. 6 is a diagram showing a waveform of the current detected by a detection circuit of the vibration-type drive apparatus or FIG. 4;

FIG. 7 is a flowchart of a control for moving the moving member of the vibration-type drive apparatus of FIG. 4 to a predetermined position; and

FIG. 8 is a flowchart of a control for calculating a traveling speed of the moving member of the vibration-type drive apparatus of FIG. 4.

### BEST MODE FOR CARRYING OUT THE INVENTION

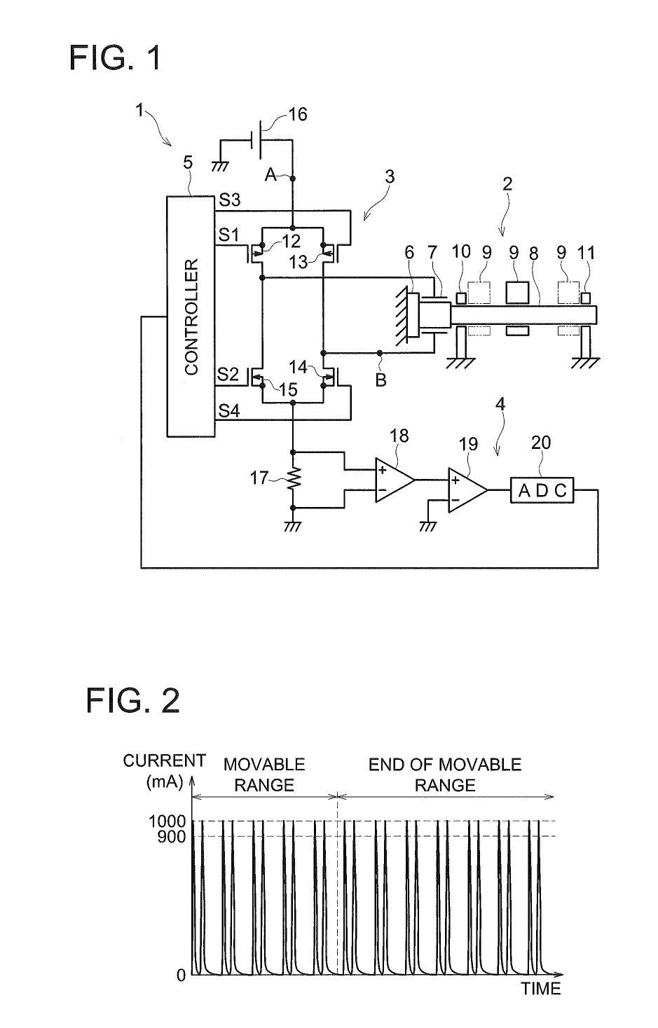

An embodiment of the present invention is described below with reference to the drawings. FIG. 1 shows a configuration of a vibration-type drive apparatus 1 of a first embodiment of the present invention. The vibration-type drive apparatus 1 includes an actuator 2 as a mechanical structural element, a drive circuit 3 for supplying a drive voltage to the actuator 2, a detection circuit 4 for detecting a drive current of the actuator 2, and a controller 5 constituted by a computer.

The actuator 2 includes a piezoelectric element (electromechanical transducer element) 7 one end of which is fixed to a weight 6 and which expands and contracts when a drive voltage is applied; a shaft-shaped drive member 8 which vibrates in the axial direction by the expansion and contraction of the piezoelectric element 7; a moving member 9 which is frictionally engaged to the drive member 8 to be slidably movable; and stopper members 10 and 11 which are in contact with the moving member 9 to limit movement of the moving member 9 to define the movable range of the moving member 9.

The drive circuit 3 is a bridge circuit in which the both electrodes of the piezoelectric element 7 are connected to a direct current power supply 16 or to the ground through four FETs 12, 13, 14, and 15 each of which is switching controlled by control signals S1, S2, S3, and S4 input from a controller 5.

The detection circuit 4 includes a comparator 18 for outputting the voltage difference between the both ends of a sensing resistor (shunt resistor) 17 provided in a circuit for earthing the piezoelectric element 7 in the drive circuit 3; an amplifier 19 for amplifying the output of the comparator 18; and an A/D converter for digitizing the output of the amplifier 19. The output of the detection circuit 4, which is a digital signal representing the current value of the discharge current of the piezoelectric element 7, is fed to the controller 5.

In the vibration-type drive apparatus 1, when a cyclic drive voltage is applied to the piezoelectric element 7 of the actuator 2 from the drive circuit 3, the drive member 8 is moved in the axial direction at a speed changing in a sawtooth manner, by the expansion and contraction of the piezoelectric element 7. The moving member 9 is moved together with the drive member 8, being frictionally engaged to the drive member 8, when the drive member 8 moves slowly; and the moving member 9 is kept where it is by its own inertial force when the drive member 8 is quickly moves, whereby the moving member 9 is slidingly displaced with respect to the drive member 8.

For example, the drive circuit 3 outputs a drive voltage of a cyclic rectangular wave with a frequency of 140 kHz and a duty factor of 0.3 to slidingly displace the moving member 9 in an extending direction in which the moving member 9 is moved away from the piezoelectric element 7, and outputs a drive voltage of a rectangular wave of a frequency of 140 kHz and a duty factor of 0.7 to slidingly displace the moving member 9 in a returning direction in which the moving member 9 gets closer to the piezoelectric element 7. This frequency of the drive voltage is lower than a resonance frequency of the actuator 2 and is equivalent to 0.7 times of the resonance frequency.

The discharge current of the piezoelectric element 7 detected by the detection circuit 4 depends on the waveform of the drive voltage (amplitude of the voltage and the switching waveform) and the impedance of the piezoelectric element 7. In other words, what the detection circuit 4 actually detects is the current flowing through the drive circuit 3, but it can be said that the detection circuit 4 detects the impedance of the piezoelectric element 7.

FIG. 2 shows the change in the value detected by the detection circuit 4, that is, the current flowing through the sensing resistor 17. The piezoelectric element 7 shows capacitive characteristics similar to a capacitor. Therefore, the current of the drive circuit 3 repeatedly changes such that the current is at its peak value at the moment the statuses of the FETs 12, 13, 14, and 15 are switched, and gradually decrease after that. In order to detect such waveform, the amplifier 20 of the detection circuit 4 A/D-converts in a sufficiently short cycle, for example, every 0.1 μS (sampling frequency of 10 MHz).

The controller 5 picks up the maximum (peak current value) in the detection value input from the detection circuit 4 for every switching cycle of the FETs 12, 13, 14, and 15. The peak value of the current of the drive circuit 3 is about 1,000 mA when the moving member 9 is located inside the movable range as shown in FIG. 2, in other words, is not in contact with the stopper member 10 or 11; however, when the moving member 9 reaches the end of the movable range and contacts the stopper members 10 or 11, the current decreases to about 900 mA. Thus, with the threshold for the peak value of the detection current of the detection circuit 4 being set at 950 mA, when the detected peak value is 950 mA or less, the controller 5 determines that the moving member 9 is in contact with the stopper member 10 or 11 (determination section), and appropriately controls the drive circuit 3, depending on the situation.

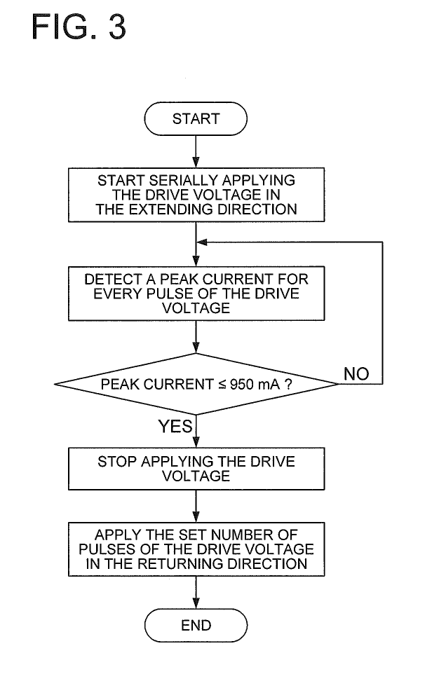

For example, in this embodiment, the control shown in FIG. 3 is performed to return the moving member 9 to the origin in the case that the origin is set at the position which is separated from the end of the movable range by a predetermined distance (for example, 50 μm) and at which the moving member 9 is in contact with the stopper member 11, and the moving member 9 is determined to be at the position obtained by multiplying the displacement amount (for example, ±0.1 μm) per one pulse by the accumulated number of pulses of the drive voltage having been applied after the moving member returned to the origin. For example, when the vibration-type drive apparatus 1 is used for driving a focusing lens, the origin of the moving member 9 is set at the position at which the focused distance is infinite. The reason why the origin of the moving member 9 set at a position separated from the end of the movable range is that a product can be designed to surely have within the movable range a position at which the focused distance is infinite, even if there are variations between products.

In this control of returning to the origin, the controller 5 picks up a peak value for every pulse of the drive voltage from the current values detected by the detection circuit while serially outputting to the drive circuit 3 the drive voltage for moving the moving member 9 in the extending direction. In the mean time, when the picked up peak value becomes 950 mA or less, the control circuit 5 immediately causes the drive circuit 3 to stop outputting the drive voltage and then to output the drive voltage, in the returning direction, containing a required number of pulses (for example 500 pulses) to move the moving member 9 from the end of the movable range to the origin.

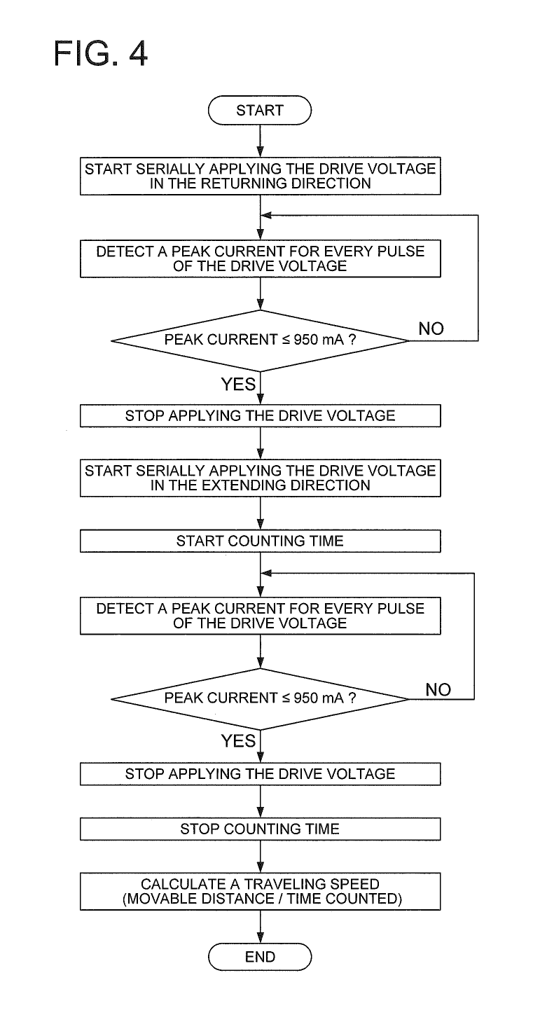

In addition, in this embodiment, as shown in FIG. 4, the moving member 9 is moved from the position at which the moving member 9 is in contact with the stopper member 10 to the position at which the moving member 9 is in contact with the stopper member 11 to measure the time period required for that operation, and the traveling speed of the moving member 9 is calculated, whereby a calculation formula for obtaining the number of pulses to be applied is corrected, where the number of pulses corresponds to a distance by which the moving member 9 should be moved. This control is performed, for example, when the vibration-type drive apparatus 1 is turned on.

In particular, as shown in FIG. 4, the controller 5 first serially outputs to the drive circuit 3 the drive voltage for moving the moving member 9 in the returning direction, and picks up for every pulse of the drive voltage a peak value from the current values detected by the detection circuit 4; and when the picked up peak value becomes 950 mA or less, the controller 5 causes the drive circuit 3 to stop outputting the drive voltage, considering the moving member 9 having been in contact with the stopper member 10. Then, the controller 5 serially outputs to the drive circuit 3 the drive voltage for moving the moving member 9 in the extending direction and causes a time counter to start counting time. In the time count, it is convenient to use one cycle of the drive voltage as a time unit.

Then, the controller 5 picks up for every pulse of the drive voltage a peak value from the current values detected by the detection circuit 4, and when the peak value becomes 950 mA or less, the controller 5 causes the drive circuit 3 to stop outputting the drive voltage and stops the time count, considering the moving member 9 having been in contact with the stopper member 11. The controller 5 finally calculates the traveling speed (a traveling distance per one pulse of the drive voltage) of the moving member 9 by diving the distance from the position at which the moving member 9 is in contact with the stopper member 10 to the position at which the moving member 9 is in contact with the stopper member 11 by the time measured by the time counter.

With this measure, the controller 5 improves the accuracy in positioning the moving member 9 by correcting the calculation formula for calculating the number of pulses of the drive voltage to be outputted to the drive circuit 3 when the signal instructing the position or the displacement amount of the moving member 9 is input from the outside. That is to say, in the vibration-type drive apparatus 1 of this embodiment, since the change in the ambient temperature and the change in the traveling speed due to uneven wear in the components are corrected by itself, there is no need for a calibration operation in a regular basis.

In the vibration-type drive apparatus 1, the control in FIG. 3 and the control in FIG. 4 can be combined, and the moving member 9 may be returned to the origin from the status that the moving member 9 is positioned in contact with the stopper member 11 to calculate the speed of the moving member 9, by applying a predetermined number of pulses of the drive voltage by the control in FIG. 4.

In addition, in this embodiment, the sensing resistor 17 is provided between the ground and the FETs 14 and 15; however, the sensing resistor 17 can be provided in the circuit (at position A) between the direct current power supply 16 and the FETs 12 and 13 or provided in the circuit (at position B) between the drive circuit 3 and the piezoelectric element 7, for example, in FIG. 1, and the voltage difference between the both ends may be detected by the detection circuit 4 to detect the impedance of the piezoelectric element 7.

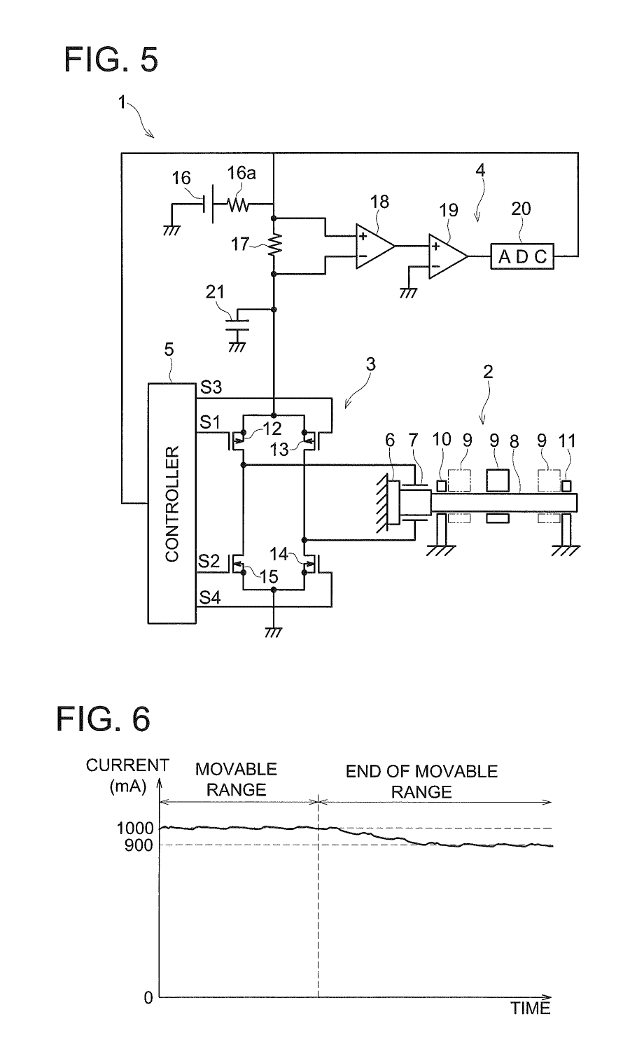

In addition, FIG. 5 shows a configuration of a vibration-type drive apparatus la of a second embodiment of the present invention. In this embodiment, the same components as those in the first embodiment are assigned the same reference numerals, and duplicated descriptions thereof are omitted.

In the vibration-type drive apparatus 1a of this embodiment, the direct current power supply 16 has a non-negligible internal resistance 16a, and hence has a high output impedance. To deal with this issue, in the vibration-type drive apparatus 1a, a smoothing capacitor 21 having a sufficient capacitance to function as a current buffer is provided in the circuit just before the FETs 12 and 13 of the drive circuit 3. In addition, in this embodiment, the sensing resistor 17 is provided between the direct current power supply 16 and the smoothing capacitor 21. Thus, the detection circuit 4 is provided to detect the impedance of the piezoelectric element 7 by sensing the voltage difference between the both ends of the sensing resistor 17.

Also in this embodiment, the charge current and the discharge current of the piezoelectric element 7 of the actuator 2 have a waveform shown in FIG. 2, similarly to the first embodiment. However, the direct current power supply 16 cannot supply an instantaneously large current due to the internal resistance 16a; thus the electric charge charged in the smoothing capacitor 21 is supplied to the piezoelectric element 7 when the current for the piezoelectric element 7 is large. Thus, the smoothing capacitor 21 is charged with electric charge little by little from the direct current power supply 16, as shown in FIG. 6. Therefore, the current waveform of FIG. 6 is a waveform in which the current waveform of FIG. 2 is smoothened, and the integral values of the both current waveforms are equal.

In this embodiment, since the detection circuit 4 detects the average value of the current flowing through the piezoelectric element 7, the controller 5 can use the detection value output from the detection circuit 4 as it is, and there is no need for such a high-speed process to detect a peak value.

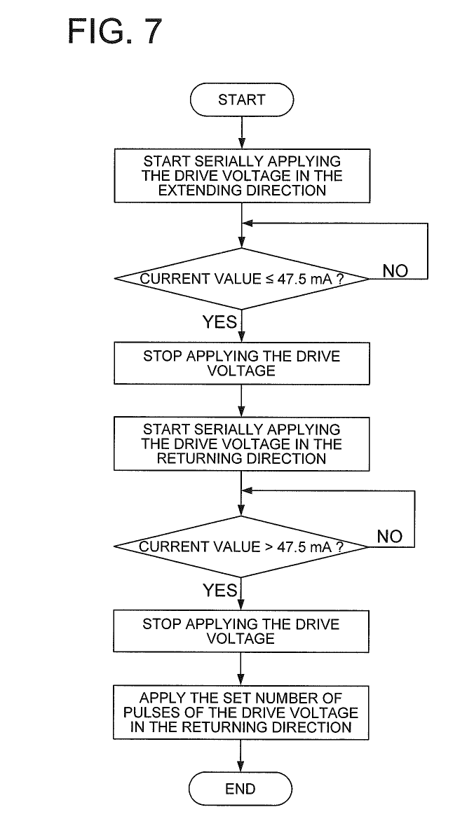

FIG. 7 shows a flow of this embodiment for returning the moving member 9 to the origin. In this embodiment, when the detection current becomes 47.5 mA or less, the moving member 9 is determined to be in contact with the stopper member 10 or 11.

In addition, in this embodiment, once moving member 9 has reached the stopper member 11 with the drive voltage in the extending direction being applied, the drive voltage in the returning direction is serially applied, and the number of pulses of the drive voltage necessary to move the moving member 9 from the end of the movable range to the origin are applied after the detection current becomes more than 47.5 mA. This is because, in this embodiment, the moving member 9 may be temporarily stuck at the end of the movable range, due to an uneven wear at the mechanical end of the movable range or the like, and the moving member may not move in spite of the drive voltage being applied. The drive voltage necessary for movement to the origin is applied after it has been confirmed that the moving member 9 is released from the stopper member 11 and starts moving.

In addition, in this embodiment, the current value detected by the detection circuit 4 is gradually decreases as shown in FIG. 6 when the moving member 9 contacts the stopper member 10 of 11, or gets separated from the stopper member 10 or 11, and the detection of the change in the impedance of the piezoelectric element 7 is accordingly delayed. To deal with this issue, it is preferable that the number of pulses of the drive voltage for moving the moving member 9 from the end of the movable range to the origin is set fewer according to this delay. When this delay is sufficiently small, for example, when the detection delay of the change in the impedance of the piezoelectric element 7 is 10 pulses or less, the positioning error of the moving member 9 is 1 μm at most, and the positioning error due to the detection delay in the detection circuit 4 is negligible. As a result, the capacitance of the smoothing capacitor 21 is optimized so as to make the detection delay by the detection circuit 4 sufficiently small, the detection delay in the detection circuit 4 can be ignored.

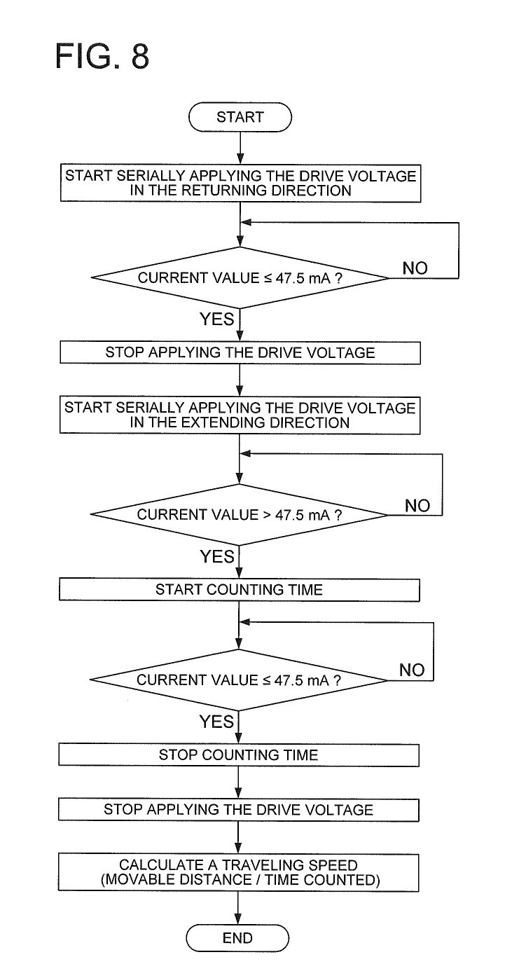

In addition, in this embodiment, as shown in FIG. 8, when the moving member 9 is driven from the position at which the moving member 9 is in contact with the stopper member 10 to the position at which the moving member 9 is in contact with the stopper member 11 in order to calculate the traveling speed of the moving member 9, the time count starts when the moving member 9 gets separated from the stopper member 10 and the detection current becomes more than 47.5 mA. In this case, the detection delay in the detection circuit 4 is the same between the start and the end of the time count, and the delays are cancelled, with the result that there is no need for consideration.

### DESCRIPTION OF THE NUMERALS

1, 1a: Vibration-type drive apparatus
2: Actuator
3: Drive circuit
4: Detection circuit
5: Controller (determination section)
6: Weight
7: Piezoelectric element (electromechanical transducer element)
8: Drive member
9: Moving member
10, 11: Stopper member
12, 13, 14, 15: FET
16: Direct current power supply
17: Sensing resistor
21: Smoothening capacitor

1. A vibration-type drive apparatus, comprising:
an piezoelectric element configured to generate a mechanical displacement in response to a voltage applied thereto;
a drive member mounted on the piezoelectric element and configured to be moved by the electromechanical transducer element;
a moving member frictionally engaged to the drive member;
a stopper member configured to limit movement of the moving member by contacting the moving member;
a drive circuit configured to apply a cyclically changing drive voltage to the piezoelectric element;
a detection circuit configured to detect an impedance of the piezoelectric element; and
a determination section configured to determine that the moving member is in contact with the stopper member when a value of the impedance detected by the detection circuit is equal to or greater than a predetermined value.

2. The vibration-type drive apparatus of claim 1, wherein the detection circuit detects a value of a current flowing through the piezoelectric element which is generated by the drive voltage applied to the piezoelectric element.

3. The vibration-type drive apparatus of claim 1, wherein the piezoelectric element generates a sawtooth shaped mechanical displacement by application of a voltage.

4-7. (canceled)

8. The vibration-type drive apparatus of claim 2, wherein the piezoelectric element generates a sawtooth shaped mechanical displacement by application of a voltage.

9. A control method for a vibration-type drive apparatus which includes: an piezoelectric element configured to generate a mechanical displacement in response to a voltage applied thereto; a drive member mounted on the piezoelectric element and configured to be moved by the electromechanical transducer element; a moving member frictionally engaged to the drive member; a stopper member configured to limit movement of the moving member by contacting the moving member, wherein an impedance of the piezoelectric element is equal to or greater than a predetermined value when the moving member is in contact with the stopper member, the method comprising the steps of:
detecting the impedance of the piezoelectric while applying a cyclically changing drive voltage to the piezoelectric element; and
stopping the application of the drive voltage when a value of the detected impedance becomes the predetermined value or greater.

10. A control method for a vibration-type drive apparatus which includes: an piezoelectric element configured to generate a mechanical displacement in response to a voltage applied thereto; a drive member mounted on the piezoelectric element and configured to be moved by the electromechanical transducer element; a moving member frictionally engaged to the drive member; a stopper member configured to limit movement of the moving member by contacting the moving member, wherein an impedance of the piezoelectric element is equal to or greater than a predetermined value when the moving member is in contact with the stopper member, the method comprising the steps of:
detecting the impedance of the electromechanical transducer element;
starting, when the moving member is in contact with the stopper member and a detection value of the impedance is equal to or greater than a predetermined value, to apply a cyclically changing drive voltage to the electromechanical transducer element so as to move the moving member in a direction that the moving member gets away from the stopper member; and then
stopping the application of the drive voltage after a predetermined period of time has elapsed since the value of the detected impedance became less than the predetermined value.

11. A control method for a vibration-type drive apparatus which includes: an electromechanical transducer element configured to generate a mechanical displacement in response to a voltage applied thereto; a drive member configured to be moved by the electromechanical transducer element; a moving member frictionally engaged to the drive member and configured to move in a first direction and a second direction opposite to the first direction; a first stopper member provided on the first direction side of the moving member and configured to limit movement of the moving member by contacting the moving member; and a second stopper member provided on the second direction side of the moving member and configured to limit the movement of the moving member by contacting the moving member, wherein the moving member is capable of moving a predetermined travel distance from the first stopper member to the second stopper member, the method comprising the steps of:
detecting an impedance of the piezoelectric element;
starting to apply a cyclically changing drive voltage to the piezoelectric element when the moving member is in contact with the first stopper member and a value of the detected impedance is equal to or greater than a predetermined value so as to move the moving member until the moving member reaches the second stopper member;
measuring, in the step of starting to apply a cyclically changing drive voltage, a travel time from when the value of the detected impedance becomes smaller than the predetermined value to when the value of the detected impedance becomes again equal to or greater than the predetermined value; and
calculating a traveling speed of the moving member, based on the travel time and the predetermined travel distance.

12. The control method of claim 5 for a vibration-type drive apparatus, wherein the piezoelectric element generates a sawtooth shaped mechanical displacement by application of a voltage.

13. The control method of claim 6 for a vibration-type drive apparatus, wherein the piezoelectric element generates a sawtooth shaped mechanical displacement by application of a voltage.

14. The control method of claim 7 for a vibration-type drive apparatus, wherein the piezoelectric element generates a sawtooth shaped mechanical displacement by application of a voltage.
